(19) United States
(12) Patent Application Publication
(10) Pub. No.: US 2026/0117390 A1
(43) Pub. Date: Apr. 30, 2026

(54) SOFT MAGNETIC COMPOSITE MATERIAL SHEET AND METHOD FOR PRODUCING SAME

(71) Applicant: Hitachi, Ltd., Tokyo (JP)

(72) Inventors: Tomohiro TABATA, Tokyo (JP); Masafumi NOUJIMA, Tokyo (JP); Yusuke ASARI, Tokyo (JP); Shohei TERADA, Tokyo (JP)

(21) Appl. No.: 19/003,446

(22) Filed: Dec. 27, 2024

(30) Foreign Application Priority Data
Jan. 30, 2024 (JP) 2024-011462

(51) Int. Cl. C23D 5/04; C03C 3/21; C03C 8/08; C03C 8/14; C23D 13/00; H01F 1/153

(52) U.S. Cl. CPC C23D 5/04; C03C 3/21; C03C 8/08; C03C 8/14; C23D 13/00; H01F 1/15308; H01F 1/15383; C03C 2207/00

(57) ABSTRACT

A soft magnetic composite material sheet according to the invention includes a soft magnetic Fe-based alloy sheet, and an electrically insulating film formed on a surface of the soft magnetic Fe-based alloy sheet. The soft magnetic Fe-based alloy sheet is a Fe-based amorphous alloy sheet or a Fe-based nanocrystal alloy sheet, the electrically insulating film contains a lead-free glass composition and has a linear expansion coefficient less than a linear expansion coefficient of the soft magnetic Fe-based alloy sheet, and the glass composition has a softening point equal to or lower than a temperature at which a microstructure of the soft magnetic Fe-based alloy sheet is maintained.

### CLAIM OF PRIORITY

The present application claims priority from Japanese patent application serial no. 2024-011462 filed on Jan. 30, 2024, the content of which is hereby incorporated by reference into this application.

### BACKGROUND OF THE INVENTION

### 1. Field of the Invention

The present invention relates to a technique for a soft magnetic material, and more particularly, to a soft magnetic composite material sheet exhibiting a low iron loss, and a method for producing the soft magnetic composite material sheet.

### 2. Description of Related Art

In an electromechanical device (for example, a rotating electrical machine or a transformer), a laminated iron core obtained by laminating and forming a plurality of soft magnetic material sheets (for example, 0.01 mm to 3 mm in thickness) such as a pure electromagnetic iron sheet or an electromagnetic steel sheet is widely used. From the viewpoint of global environmental protection, the field of application of an electromechanical device using a soft magnetic material has recently been expanding, and along with this, there is an increasing demand for high power and miniaturization of the electromechanical device. In other words, a demand for increasing the power density (power per unit mass, W/kg) of the electromechanical device is increasing.

When a rotating electrical machine is assumed as the electromechanical device, the power thereof is proportional to the product of a rotation speed and a torque during operation, and therefore, the power can be increased by increasing either the rotation speed or the torque. The torque is proportional to the product of the magnetic flux density and the current value. In order to increase the magnetic flux density, it is desirable to use a soft magnetic material that achieves a high saturation magnetic flux density Bs. In order to increase Bs, various attempts have been made to control the composition and microstructure of soft magnetic materials.

On the other hand, in the case of increasing the rotation speed during operation, the conversion efficiency between electrical energy and magnetic energy is important, and it is a problem to reduce the loss (iron loss Pi) in the soft magnetic material sheet. Pi is a sum of a hysteresis loss and an eddy current loss. The coercive force Hc is desired to be small in order to reduce the hysteresis loss, and it is effective to increase electrical resistance and make the sheet thin in order to reduce the eddy current loss.

Therefore, in order to increase the power density of the electromechanical device, it is desirable to achieve both high Bs and low Pi in the soft magnetic material.

Fe—Si alloy-based electromagnetic steel sheets are currently widely used as materials in which relatively high Bs and relatively low Pi are well balanced. On the other hand, in recent years, a Fe (iron)-based amorphous alloy sheet and a Fe-based nanocrystal alloy sheet have attracted attention as materials exhibiting lower Pi than Fe—Si alloy-based electromagnetic steel sheets. An electromechanical device using a soft magnetic material has a wide variety of applications and sizes, and therefore, in order to satisfy various required characteristics in the design of the electromechanical device, a technique for stably producing a soft magnetic material has been actively developed.

For example, JP2022-113111A discloses a thin soft-magnetic alloy ribbon in which an alloy composition is represented by a composition formula (Fe₁₋ₓAₓ)ₐSi_{b}B_{c}Cu_{d}Mₑ), A represents at least one of Ni and Co, M represents one or more selected from the group including Nb, Mo, V, Zr, Hf, and W, and in atom %, 82.4≤a≤86, 0.2≤b≤2.4, 12.5≤c≤15.0, 0.05≤d≤0.8, 0.4≤e≤1.0, and 0≤x≤0.1 are satisfied. The thin soft-magnetic alloy ribbon has a structure in which crystal grains having a grain size of 60 nm or less are present in an amorphous phase, and has a saturation magnetic flux density of 1.74 T or more and an iron loss at 1 KHz and 1 T of 25 W/kg or less.

According to PTL 1, a thin soft-magnetic alloy ribbon having a high saturation magnetic flux density and a low iron loss and a method for producing the thin soft-magnetic alloy ribbon can be obtained.

### CITATION LIST

### Patent Literature

PTL 1: JP2022-113111A

### SUMMARY OF THE INVENTION

As described above, the demand for increasing the power density (W/kg) of the electromechanical device is increasing. Recently, an increase in the rotation speed and an increase in the frequency during operation have been advanced as methods for increasing the power of the electromechanical device. However, an increase in the power due to an increase in the rotation speed and an increase in the frequency causes large problems such as the energy loss and efficiency reduction due to Pi of the soft magnetic material.

The invention has been made to solve the above problems. A first object of the invention is to provide a soft magnetic composite material sheet having lower Pi than a Fe-based amorphous alloy sheet and a Fe-based nanocrystal alloy sheet according to the related art, and a method for producing the same.
(I) An aspect of the invention provides a soft magnetic composite material sheet including:
a soft magnetic Fe-based alloy sheet; and
an electrically insulating film formed on a surface of the soft magnetic Fe-based alloy sheet, in which
the soft magnetic Fe-based alloy sheet is a Fe-based amorphous alloy sheet or a Fe-based nanocrystal alloy sheet,
the electrically insulating film contains a lead-free glass composition and has a linear expansion coefficient less than a linear expansion coefficient of the soft magnetic Fe-based alloy sheet, and
the glass composition has a softening point equal to or lower than a temperature at which a microstructure of the soft magnetic Fe-based alloy sheet is maintained.

In the invention, the linear expansion coefficient of the glass composition is defined as an average linear expansion coefficient from room temperature to a glass transition point Tg (see FIG. 4 described below), and the linear expansion coefficient of the soft magnetic Fe-based alloy sheet is defined as an average linear expansion coefficient from room temperature to a first crystallization temperature (see FIG. 3 described below).

In the invention, the following improvements and modifications can be freely combined in and added to (I) the soft magnetic composite material sheet according to the invention.
(i) The glass composition contains, when a nominal component is represented by an oxide,
   V₂O₅ (vanadium oxide) in an amount of 40 mass % or more and 70 mass % or less, P₂O₅ (phosphorus oxide) in an amount of 10 mass % or more and 35 mass % or less, a total content of V₂O₅ and P₂O₅ being 50 mass % or more and 98 mass % or less, and
   two or more from the group including BaO (barium oxide), Sb₂O₃ (antimony oxide), WO₃ (tungsten oxide), ZnO (zinc oxide), K₂O (potassium oxide), Fe₂O₃ (iron oxide), TeO₂ (tellurium oxide), Ag₂O (silver oxide), and Li₂O (lithium oxide) in a total amount of 2 mass % or more and 50 mass % or less,
   with a balance being unavoidable impurities.
(ii) The electrically insulating film contains an oxide particle filler in an amount of 75 vol % or less, and
the filler is one or more from the group including SiO₂ (silicon oxide), ZrO₂ (zirconium oxide), Al₂O₃ (aluminum oxide), Nb₂O₅ (niobium oxide), ZrSiO₄ (zirconium silicate), Zr₂(WO₄)(PO₄)₂ (zirconium tungstate phosphate), 2MgO·2Al₂O₃·5SiO₂ (cordierite), 3Al₂O₃·2SiO₂ (mullite), and LiAlSiO₄ (eucryptite).
(iii) The linear expansion coefficient of the electrically insulating film is less than 10 ppm/° C., and the softening point of the glass composition is 500° C. or lower.
(iv) A tensile strain within a range of 1 μST or more and 1000 μST or less is generated in the soft magnetic Fe-based alloy sheet along an in-plane direction of the soft magnetic Fe-based alloy sheet.
(II) Another aspect of the invention provides a method for producing a soft magnetic composite material sheet, which is a method for producing the above soft magnetic composite material sheet, the method including:
a soft magnetic Fe-based alloy sheet preparing step of preparing the soft magnetic Fe-based alloy sheet;
a glass paste preparing step of preparing a glass paste serving as a base for the electrically insulating film;
a soft magnetic composite material precursor forming step of forming a soft magnetic composite material precursor by applying the glass paste to at least one main surface of the soft magnetic Fe-based alloy sheet; and
an electrically insulating film forming step of forming the electrically insulating film by performing heat treatment on the soft magnetic composite material precursor.

In the invention, the following improvements and modifications can be freely combined in and added to (II) the method for producing the soft magnetic composite material sheet according to the invention.
(v) The heat treatment in the electrically insulating film forming step includes a drying process of heating and holding the soft magnetic composite material precursor at 120° C. or higher and 200° C. or lower, and a firing process of heating and holding the soft magnetic composite material precursor at a temperature higher than the softening point of the glass composition by 20° C. to 50° C., and
a highest temperature in the firing process is lower than a crystallization peak temperature of the glass composition and lower than a second crystallization temperature of the soft magnetic Fe-based alloy sheet.

According to the invention, it is possible to provide a soft magnetic composite material sheet having lower Pi than a Fe-based amorphous alloy sheet and a Fe-based nanocrystal alloy sheet according to the related art, and a method for producing the same.

The problems, configurations, and effects other than those described above will become apparent from the following description of the embodiment.

### BRIEF DESCRIPTION OF THE DRAWINGS

FIG. 1 is a schematic cross-sectional view showing a structural example of a soft magnetic composite material sheet according to the invention;

FIG. 2 shows an example of a chart (DTA curve) obtained in a temperature rise process of differential thermal analysis (DTA) for a Fe-based amorphous alloy sheet used in the invention;

FIG. 3 shows an example of a chart (DTA curve) obtained in a temperature rise process of DTA for a glass composition used in the invention;

FIG. 4 is a flowchart showing an outline of a method for producing the soft magnetic composite material sheet according to the invention;

FIG. 5 is a flowchart showing an outline of a method for producing a laminated iron core using the soft magnetic composite material sheet according to the invention;

FIG. 6A is a schematic perspective view showing an example of a stator of a rotating electrical machine; and

FIG. 6B is an enlarged schematic cross-sectional view of a slot region of the stator.

### DESCRIPTION OF EMBODIMENTS

### Basic Concept of the Invention

The present inventors have focused on low Pi exhibited by a Fe-based amorphous alloy sheet and a Fe-based nanocrystal alloy sheet, and have studied a technique of further reducing Pi. In the study, the present inventors have found that Pi decreases when a tensile strain in an in-plane direction is applied to the Fe-based alloy sheet. On the other hand, the present inventors have also confirmed that there is a difficulty that, when the Fe-based alloy sheet is subjected to a treatment for applying a tensile strain in the in-plane direction (for example, heating at a temperature equal to or higher than a predetermined temperature), undesired crystallization or crystal grain coarsening occurs, an original microstructure cannot be maintained, and Pi significantly increases.

The present inventors have conducted intensive studies on a technique of applying a tensile strain in the in-plane direction to the Fe-based alloy sheet while maintaining a microstructure originally possessed by the Fe-based amorphous alloy sheet and the Fe-based nanocrystal alloy sheet. As a result, the present inventors have found that the object can be further achieved by forming a composite material sheet in which a predetermined lead-free glass composition is formed on a surface of the Fe-based alloy sheet as an electrically insulating film. The invention has been completed based on this finding.

Hereinafter, embodiments of the invention will be described with reference to the drawings. The invention is not limited to the specific embodiments described above, and can be appropriately combined with known techniques or improved based on known techniques without departing from the technical idea of the invention.

### Soft Magnetic Composite Material Sheet of the Invention

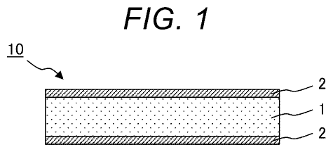

FIG. 1 is a schematic cross-sectional view showing a structural example of a soft magnetic composite material sheet according to the invention. As shown in FIG. 1, a soft magnetic composite material sheet 10 according to the invention is a composite material sheet in which an electrically insulating film 2 is formed on at least one surface of a soft magnetic Fe-based alloy sheet 1.

The soft magnetic Fe-based alloy sheet 1 is made of a Fe-based amorphous alloy sheet or a Fe-based nanocrystal alloy sheet. In other words, the soft magnetic Fe-based alloy sheet 1 is an alloy sheet having a microstructure including a Fe-based amorphous alloy phase and/or a Fe-based nanocrystal alloy phase.

There is no particular limitation on the Fe-based amorphous alloy sheet and the Fe-based nanocrystal alloy sheet used in the invention, and any of the sheets according to the related art can be appropriately used. In the invention, the Fe-based nanocrystal alloy sheet basically means an alloy sheet in which a Fe-based nanocrystal alloy phase is finely dispersed in a matrix of a Fe-based amorphous alloy phase, and may be an alloy sheet only including a Fe-based nanocrystal alloy phase.

The electrically insulating film 2 is a lead-free glass composition layer. The glass composition has a softening point equal to or lower than a temperature at which the microstructure of the soft magnetic Fe-based alloy sheet 1 is maintained, and has a linear expansion coefficient less than the linear expansion coefficient of the soft magnetic Fe-based alloy sheet 1. When the electrically insulating film 2 is formed while the temperature rises to an appropriate temperature, a compressive stress can be applied to the electrically insulating film 2, and a tensile stress can be applied to the soft magnetic Fe-based alloy sheet 1 due to a difference in the linear expansion coefficients during cooling.

The studies by the present inventors have revealed that Pi can be significantly reduced when a tensile strain within an elastic deformation range is applied to the soft magnetic Fe-based alloy sheet 1 in the in-plane direction. On the other hand, when the tensile strain in a plastic deformation region is applied to the soft magnetic Fe-based alloy sheet 1, Pi increases. The amount of strain applied to the soft magnetic Fe-based alloy sheet 1 is preferably within a range of 1 μST or more and 1000 μST or less (ST is a notation that means the amount of strain), more preferably within a range of 10 μST or more and 500 μST or less, and still more preferably within a range of 20 μST or more and 200 μST or less.

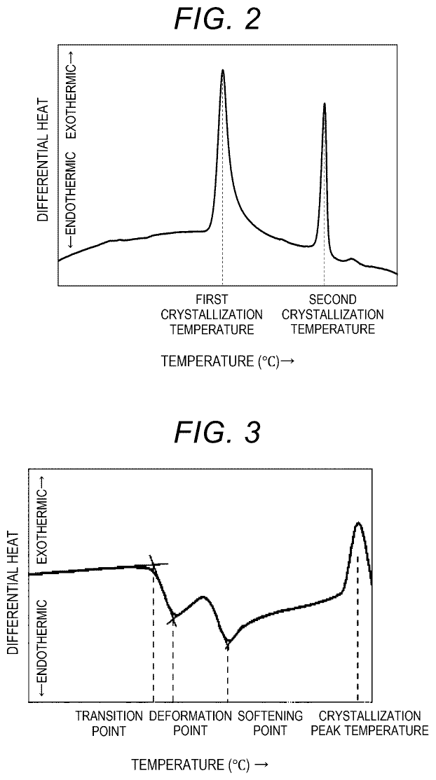

FIG. 2 shows an example of a chart (DTA curve) obtained in a temperature rise process of differential thermal analysis (DTA) for the Fe-based amorphous alloy sheet used in the invention. As shown in FIG. 2, when the Fe-based amorphous alloy sheet is heated, two large exothermic peaks are observed. The first exothermic peak is considered to be an exothermic reaction in which crystallization starts partially from the amorphous phase (exothermic reaction in which the nanocrystal alloy phase starts to nucleate and crystallize), and a peak temperature of the first exothermic peak is defined as the first crystallization temperature. The second exothermic peak is considered to be an exothermic reaction in which the original amorphous phases are entirely crystallized and the nanocrystal alloy phases are combined with each other to start coarsening, and a peak temperature of the second exothermic peak is defined as the second crystallization temperature.

Naturally, specific values of the first crystallization temperature and the second crystallization temperature vary depending on the alloy composition and microstructure of the Fe-based amorphous alloy sheet and the Fe-based nanocrystal alloy sheet. In general, the first crystallization temperature is about 400° C. to 550° C., and the second crystallization temperature is about 500° C. to 600° C.

It is known that the Fe-based nanocrystal alloy sheet can be obtained by subjecting a Fe-based amorphous alloy sheet to heat treatment at a temperature between the first crystallization temperature and the second crystallization temperature. However, when the heat treatment is performed at a temperature equal to or higher than the second crystallization temperature, Pi of the alloy sheet rapidly increases.

FIG. 3 shows an example of a chart (DTA curve) obtained in a temperature rise process of DTA for a glass composition used in the invention. As shown in FIG. 3, an onset temperature of a first endothermic peak is defined as a glass transition point Tg (corresponding to a viscosity of 10^{13.3} poise), a peak temperature of the first endothermic peak is defined as a deformation point Td (corresponding to a viscosity of 10^{11.0} poise), a peak temperature of a second endothermic peak is defined as a softening point Ts (corresponding to a viscosity of 10^{7.65} poise), and the peak temperature of the first exothermic peak is defined as a crystallization peak temperature Tcp. Each temperature is determined by a tangential method.

The glass composition having lower characteristic temperatures, i.e., Tg, Td, and Ts is more likely to soften and flow at a lower temperature, and can form the electrically insulating film 2 at a low temperature. The electrically insulating film 2 is preferably formed at a temperature higher than Ts by about 20° C. to 50° C. from the viewpoint of workability and temperature controllability. On the other hand, when the glass composition is crystallized, the softening fluidity is significantly impaired, and the adhesion of the film is significantly reduced. Therefore, the film is required to be formed at a temperature lower than Tcp.

Therefore, the glass composition forming the electrically insulating film 2 preferably has a characteristic temperature at which a temperature difference between Ts and Tcp is about 20° C. to 50° C. or higher. In addition, it is preferable to use a glass composition having Ts lower than the second crystallization temperature of the soft magnetic Fe-based alloy sheet 1 by 20° C. or higher. More specifically, the glass composition used in the invention preferably has a Ts of 500° C. or lower, more preferably 450° C. or lower, and still more preferably 420° C. or lower.

It is not preferable that the electrically insulating film of the soft magnetic composite material sheet softens and fluidizes when the electromechanical device is used. Therefore, when the soft magnetic composite material sheet 10 of the invention is used, it is preferable that Ts of the glass composition is higher than the temperature when the electromechanical device is used. For example, when the operating temperature of the electromechanical device is 150° C., the Ts of the glass composition is preferably higher than 150° C.

Electrical equipment used in Europe is affected by the RoHS Directive (a European Union Directive on the restriction of the use of certain hazardous substances in electronic and electrical equipment, which came into effect on Jul. 1, 2006). As a glass composition having a low Ts, a glass composition containing PbO (lead oxide) as a main component has been widely used. However, Pb is designated as a prohibited substance under the RoHS Directive, and therefore, there is a problem in that it cannot comply with the RoHS Directive. Therefore, a glass composition containing no Pb component (lead-free glass composition) is used in the soft magnetic composite material sheet targeted by the invention.

The lead-free glass composition used in the invention contains, when a nominal component is represented by an oxide, V₂O₅ in an amount of 40 mass % or more and 70 mass % or less, P₂O₅ in an amount of 10 mass % or more and 35 mass % or less, a total content of V₂O₅ and P₂O₅ being 50 mass % or more and 98 mass % or less, two or more from the group including BaO, Sb₂O₃, WO₃, ZnO, K₂O, Fe₂O₃, TeO₂, Ag₂O, and Li₂O in a total amount of 2 mass % or more and 50 mass % or less, with a balance being unavoidable impurities. The term “lead-free” used in the invention means that the prohibited substance specified in the aforementioned RoHS Directive is contained within a range of a specified value or less.

In the lead-free glass composition used in the invention, V₂O₅ is a component contributing to lowering a temperature at which glass softens and flows. P₂O₅ is a component capable of forming a skeleton of glass and is also a component contributing to preventing crystallization of glass. BaO, Sb₂O₃, WO₃, ZnO, K₂O, and Fe₂O₃ are components that contribute to improving moisture resistance and water resistance of the glass and preventing crystallization. TeO₂ and Ag₂O are components that contribute to lowering the temperature at which glass softens and flows, as with V₂O₅. Li₂O is a vitrification component that contributes to improving pressure-sensitive adhesion and adhesion.

A lead-free glass composition having a desirable characteristic temperature can be obtained by controlling the above components and contents.

In order to apply the tensile strain in the in-plane direction of the soft magnetic Fe-based alloy sheet 1, the electrically insulating film 2 preferably has a linear expansion coefficient less than the linear expansion coefficient (generally 10 ppm/° C. or more) of the soft magnetic Fe-based alloy sheet 1. The lead-free glass composition used in the invention is an oxide glass, and therefore, the lead-free glass composition has a linear expansion coefficient less than that of the soft magnetic Fe-based alloy sheet 1 which is a metal material. However, when the difference between the linear expansion coefficients is too small, a sufficient tensile strain cannot be applied.

From the viewpoint of controlling the linear expansion coefficient of the electrically insulating film 2, a filler may be mixed with the lead-free glass composition. Of course, the mixing of the filler is not essential. The filler is preferably oxide particles from the viewpoint of compatibility with the oxide glass, and for example, one or more from the group including SiO₂, ZrO₂, Al₂O₃, Nb₂O₅, ZrSiO₄, Zr₂(WO₄)(PO₄)₂, 2MgO·2Al₂O₃·5SiO₂, 3Al₂O₃·2SiO₂, and LiALSiO₄ can be suitably used. The shape of the oxide particles is preferably spherical (for example, the ratio of minor diameter/major diameter is 0.8 or more).

An average particle diameter of the filler is preferably 0.1 μm or more and 10 μm or less, and more preferably 0.5 μm or more and 5 μm or less. When the filler is mixed, the mixing ratio is preferably 75 vol % or less, more preferably 70 vol % or less, and still more preferably 5 vol % or more and 70 vol % or less.

When the electrically insulating film 2 is formed by mixing the filler with the lead-free glass composition, the linear expansion coefficient of the electrically insulating film 2 can be controlled, and the viscosity during the softening and flow can be controlled. When the average particle diameter and the mixing ratio of the filler are controlled, a distance between the soft magnetic Fe-based alloy sheets 1/a thickness of the electrically insulating film 2 can be easily controlled when the soft magnetic Fe-based alloy sheets 1 are laminated.

### Method for Producing Soft Magnetic Composite Material Sheet

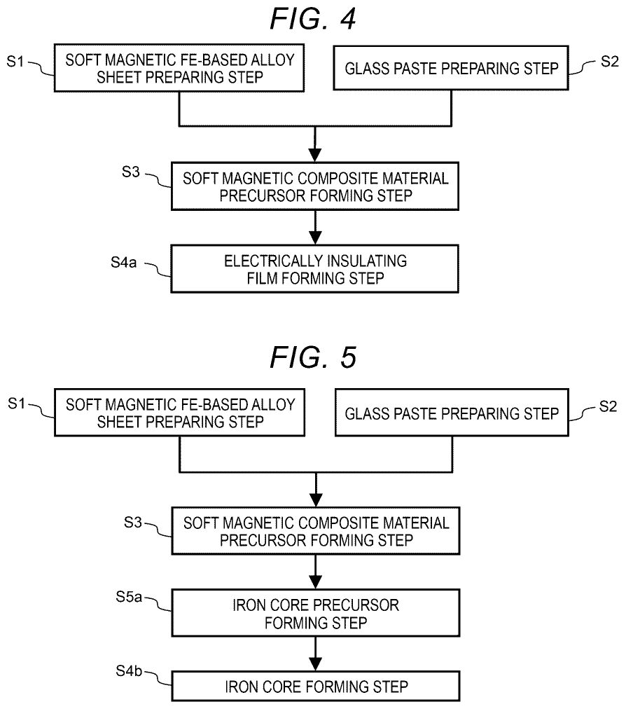

FIG. 4 is a flowchart showing an outline of a method for producing a soft magnetic composite material sheet according to the invention. As shown in FIG. 4, a soft magnetic Fe-based alloy sheet preparing step S1 of preparing the soft magnetic Fe-based alloy sheet 1 and a glass paste preparing step S2 of preparing a glass paste serving as a base for the electrically insulating film 2 are performed. The order of step S1 and step S2 is not limited.

Next, a soft magnetic composite material precursor forming step S3 of forming a soft magnetic composite material precursor by applying the glass paste prepared in step S2 to at least one main surface of the soft magnetic Fe-based alloy sheet 1 prepared in step S1 is performed.

Next, an electrically insulating film forming step S4a of forming the electrically insulating film 2 by performing heat treatment on the soft magnetic composite material precursor is performed. Accordingly, the soft magnetic composite material sheet 10 according to the invention is obtained.

FIG. 5 is a flowchart showing an outline of a method for producing a laminated iron core using the soft magnetic composite material sheet according to the invention. As shown in FIG. 5, first, steps S1 to S3 are performed similarly to the method for producing the soft magnetic composite material sheet shown in FIG. 4.

Next, an iron core precursor forming step S5a of forming an iron core precursor by laminating a plurality of soft magnetic composite material precursors is performed.

Next, an iron core forming step S4b of forming a laminated iron core by performing heat treatment on the iron core precursor to form the electrically insulating film 2 and by joining the soft magnetic Fe-based alloy sheets 1 to each other via the electrically insulating film 2 is performed. Accordingly, the laminated iron core using the soft magnetic composite material sheet 10 according to the invention is obtained.

Although illustration is omitted, another method for producing a laminated iron core may be a method in which after the soft magnetic composite material sheet 10 according to the invention is once produced, the soft magnetic composite material laminate forming step S5b of forming a soft magnetic composite material laminate by laminating a plurality of soft magnetic composite material sheets 10 is performed, and then an iron core forming step S4c of forming a laminated iron core by performing heat treatment on the soft magnetic composite material laminate to soften and fluidize and cure the electrically insulating film 2 again and by joining the soft magnetic Fe-based alloy sheets 1 to each other is performed.

Each step will be described more specifically.

Step S1 is a step of preparing the soft magnetic Fe-based alloy sheet 1. There is no particular limitation on this step as long as a desired soft magnetic Fe-based alloy sheet 1 can be prepared, and those procured from commercially available Fe-based amorphous alloy sheets or Fe-based nanocrystal alloy sheets.

As a part of this step, a soft magnetic Fe-based alloy sheet shaping step of processing the soft magnetic Fe-based alloy sheet 1 into a desired shape may be performed. There is no particular limitation on the method for shaping the soft magnetic Fe-based alloy sheet 1, and a metal processing method according to the related art (for example, punching) can be appropriately used.

Step S2 is a step of preparing a glass paste serving as a base for the electrically insulating film 2. The glass paste is obtained by mixing a resin binder and a solvent with a powder of the lead-free glass composition described above or a glass frit obtained by mixing the filler described above with the powder.

When the filler is mixed with the glass frit, as described above, the amount of the lead-free glass composition is preferably 25 vol % or more and 80 vol % or less, and the filler is preferably 20 vol % or more and 75 vol % or less. As the resin binder for the glass paste, for example, nitrocellulose may be preferably used. As the solvent for the glass paste, for example, butyl carbitol acetate or α-terpineol may be preferably used. The mixing ratios of the resin binder and the solvent may be appropriately adjusted in consideration of workability of applying the glass paste.

Step S3 is a step of forming a soft magnetic composite material precursor by applying the glass paste prepared in step S2 to at least one main surface of the soft magnetic Fe-based alloy sheet 1 prepared in step S1. There is no particular limitation on the coating method as long as the thickness (for example, on the order of micrometers) of the coating film of the glass paste can be controlled. For example, a doctor blade method can be suitably used.

Step S4a is a step of forming the electrically insulating film 2 by performing heat treatment on the soft magnetic composite material precursor prepared in step S3. In the heat treatment pattern, for example, a drying process of heating and holding the coating film at 120° C. to 200° C. is performed to dry the moisture, the binder component, and the solvent component in the coating film, and then a firing process of heating and holding the coating film at a temperature higher than Ts of the used lead-free glass composition by 20° C. to 50° C. is performed. The highest temperature of the firing process is lower than Top of the used lead-free glass composition and lower than the second crystallization temperature of the used soft magnetic Fe-based alloy sheet 1.

After the formation of the electrically insulating film 2 by the firing process, a compressive stress is applied to the electrically insulating film 2, and a tensile stress is applied to the soft magnetic Fe-based alloy sheet 1 due to the difference in linear expansion coefficients when cooling is performed. A ceramic material generally exhibits embrittlement with respect to the tensile stress, but is very strong with respect to the compressive stress. Therefore, the ceramic material can be maintained/fixed when the tensile strain in the in-plane direction is applied to the soft magnetic Fe-based alloy sheet 1.

In order to adjust the tensile strain of the soft magnetic Fe-based alloy sheet 1, the heat treatment may be performed when a tensile stress is applied to the soft magnetic Fe-based alloy sheet 1.

Step S5a is a step of forming an iron core precursor by laminating a plurality of soft magnetic composite material precursors prepared in step S3. There is no particular limitation on the method for laminating the soft magnetic composite material precursors, and a method for laminating laminated iron cores according to the related art can be appropriately used.

Step S4b is a step of forming a laminated iron core by performing heat treatment on the iron core precursor prepared in step S5a to form the electrically insulating film 2 and by joining the soft magnetic Fe-based alloy sheets 1 to each other via the electrically insulating film 2. The heat treatment pattern is basically the same as that in step S4a except that the difference in the heat capacity of the heat-treated article is considered. From the viewpoint of controlling the distance between the soft magnetic Fe-based alloy sheets 1 and the thickness of the electrically insulating film 2 in the laminated iron core, it is preferable to apply pressure in a lamination direction during the heat treatment (particularly during the firing process).

When the soft magnetic Fe-based alloy sheet shaping step is not performed in step S1, an iron core shaping step of processing the laminated iron core into a desired shape may be performed as a part of this step. There is no particular limitation on the method for shaping the laminated iron core, and a metal processing method (for example, laser processing, and water jet processing) according to the related art can be appropriately used.

Step S5b is a step of forming a soft magnetic composite material laminate by laminating a plurality of soft magnetic composite material sheets 10 prepared in step S4a. As in step S5a, there is no particular limitation on the method for laminating the soft magnetic composite material sheets 10, and a method for laminating laminated iron cores according to the related art can be appropriately used.

Step S4c is a step of forming a laminated iron core by performing heat treatment on the soft magnetic composite material laminate prepared in step S5b to soften and fluidize and cure the electrically insulating film 2 again, and by joining the soft magnetic Fe-based alloy sheets 1 to each other via the electrically insulating film 2. The heat treatment pattern is basically the same as that in step S4b, and the drying process may be omitted.

When the soft magnetic Fe-based alloy sheet shaping step is not performed in step S1, an iron core shaping step of processing the laminated iron core into a desired shape may be performed as a part of this step as in step S4b.

### Stator and Rotating Electrical Machine Using Soft Magnetic Composite Material Sheet of the Invention

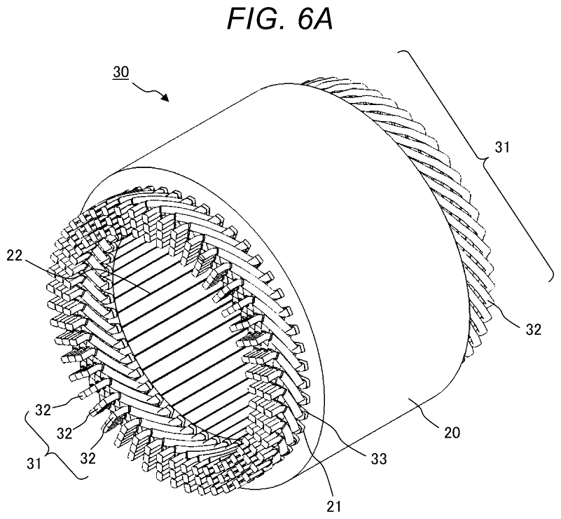

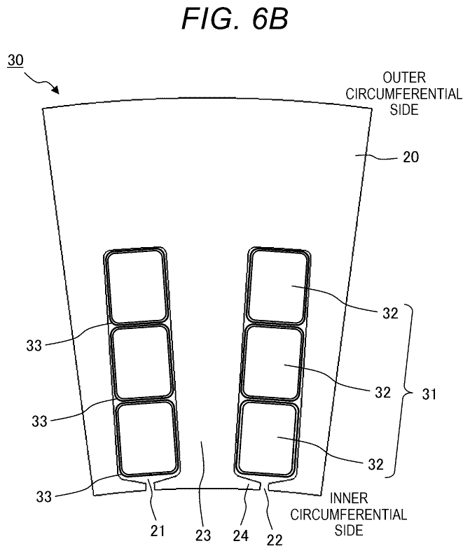

FIG. 6A is a schematic perspective view showing an example of a stator of a rotating electrical machine, and FIG. 6B is a schematic enlarged cross-sectional view of a slot region of the stator. A transverse cross section means a cross section perpendicular to a rotation axis direction (a cross section in which a normal line is parallel to an axial direction). In the rotating electrical machine, a rotator (not shown) is disposed radially inside the stator shown in FIGS. 6A and 6B.

As shown in FIGS. 6A and 6B, in the stator 30, a stator coil 31 is wound around a plurality of stator slots 21 formed on an inner circumferential side of a laminated iron core 20. The stator slots 21 are spaces arranged at a predetermined circumferential pitch in a circumferential direction of the laminated iron core 20 and formed to penetrate in the axial direction. Axially extending slits 22 are formed in the innermost circumferential portion. A region partitioning adjacent stator slots 21 is referred to as a tooth 23 of the laminated iron core 20, and a portion defining the slit 22 in a distal end region on an inner circumferential side of the tooth 23 is referred to as a tooth claw portion 24.

The stator coil 31 generally includes a plurality of segment conductors 32. For example, in FIGS. 6A and 6B, the stator coil 31 includes three segment conductors 32 corresponding to a U-phase, a V-phase, and a W-phase of a three-phase alternating current. From the viewpoint of preventing partial discharge between the segment conductors 32 and the laminated iron core 20 and partial discharge between the phases (U-phase, V-phase, and W-phase), the outer circumference of each segment conductor 32 is generally covered with an electrically insulating material 33 (for example, insulating paper or enamel coating).

The term “rotating electrical machine” as used herein refers to a rotating electrical machine using the laminated iron core 20 in which the soft magnetic composite material sheet 10 of the invention is used. The laminated iron core 20 exhibits lower Pi than a laminated iron core formed of an electromagnetic steel sheet according to the related art, a Fe-based amorphous alloy sheet according to the related art, or a Fe-based nanocrystal alloy sheet according to the related art, and therefore, an increase in the rotation speed and an increase in the frequency can be effectively handled while preventing the energy loss and a decrease in efficiency in rotating electrical machines. As a result, the rotating electrical machine can improve the power density as compared with the related art.

### EXAMPLES

Hereinafter, the invention will be described more specifically by various experiments. However, the invention is not limited to the configurations and structures described in the experiments.

### Experiment 1

### Preparation of Soft Magnetic Fe-Based Alloy Sheets SMP-1 and SMP-2

As a soft magnetic Fe-based alloy sheet SMP-1, a Fe-based amorphous alloy sheet (1K101, thickness: 25 μm, manufactured by Magprost) was prepared, and as a soft magnetic Fe-based alloy sheet SMP-2, a Fe-based nanocrystal alloy sheet (NANOMET (registered trademark), NMAQ, thickness: 25 μm, manufactured by Magprost) was prepared. The NMAQ is an alloy sheet that becomes a Fe-based nanocrystal alloy sheet by predetermined nanocrystallization heat treatment.

### Investigation on Properties of Soft Magnetic Fe-Based Alloy Sheets SMP-1 and SMP-2

The crystallization temperatures of the prepared SMP-1 and SMP-2 were measured using a differential thermal analyzer (model: TG/DTA6200, manufactured by Hitachi High-Tech Corporation). The results are shown in Table 1 below. FIG. 1 shown above is a DTA chart of the SMP-1.

Based on the results of DTA measurement, heat treatment was performed on the SMP-1 and the SMP-2 to investigate the influence on Pi. The iron loss Pi_{-1.0/400} (unit: W/kg) of a sample was measured under the conditions of a magnetic flux density of 1.0 T, 400 Hz, and a temperature of 20° C. by an H-coil method (according to JIS C 2556: 2015) using a BH loop analyzer (IF-BH550, manufactured by IFG) and a vertical yoke single-plate tester. The results are also shown in Table 1.

TABLE 1
Table 1 Results of Investigation on Properties of
Soft Magnetic Fe-Based Alloy Sheets SMP-1 and SMP-2

| | First | Second | Heat | |
|---|---|---|---|---|
| | crystallization | crystallization | treatment | Iron loss |
| Sample | temperature | temperature | temperature | Pi_{-1.0/400} |
| No. | (° C.) | (° C.) | (° C.) | (W/kg) |
| SMP-1 | 533 | 557 | 505 | 2.08 |
| SMP-2 | 395 | 514 | | 3.53 |
| SMP-1 | 533 | 557 | 700 | 200 |
| SMP-2 | 395 | 514 | | 84 |

As shown in Table 1, it is found that the SMP-1 and the SMP-2 both show sufficiently low Pi_{-1.0/400} in the heat treatment at a temperature (505° C.) lower than the second crystallization temperature. On the other hand, it is found that Pi_{-1.0/400} dramatically increases when the heat treatment is performed at a temperature (700° C.) higher than the second crystallization temperature.

### Experiment 2

### Preparation of Lead-Free Glass Compositions G-1 to G-3

Lead-free glass compositions G-1 to G-3 having a nominal composition shown in Table 2 below were prepared. The nominal composition in the table is expressed as a mass ratio of each component in terms of an oxide. As the starting materials, V₂O₅ (manufactured by Kojundo Chemical Lab. Co., Ltd., purity: 99.9%), P₂O₅ (manufactured by Kojundo Chemical Lab. Co., Ltd., purity: 99.9%), BaCO₃ (manufactured by Kojundo Chemical Lab. Co., Ltd., purity: 99.9%), and Sb₂O₃ (manufactured by Fuji Film Wako Pure Chemical Research Co., Ltd., purity: 99.9%) were used. As can be seen from the purity of the starting materials, the lead-free glass composition used in the invention contains a certain degree of unavoidable impurities.

A platinum crucible into which the mixed raw material powder was charged was placed in a glass melting furnace, followed by heating to 900° C. at a heating rate of 5° C./min to melt the mixed raw material powder, and the molten solution was held for 1 hour while being stirred with an alumina rod in order to make the composition of the molten solution in the platinum crucible uniform. Thereafter, the platinum crucible was taken out from the glass melting furnace, and the molten solution was poured into a graphite mold previously heated to 300° C. to prepare a bulk of the glass composition. Next, the cast bulk was moved to a strain relief furnace which had been heated to a strain relief temperature in advance, held for 1 hour to remove the strain, and then cooled to room temperature at a rate of 1° C./min. The bulk cooled to the room temperature was pulverized using a stamp mill and a jet mill to prepare powders of the lead-free glass compositions G-1 to G-3.

### Measurement of Characteristic Temperature of Lead-Free Glass Compositions G-1 to G-3

The characteristic temperatures of G-1 to G-3 were measured using the same differential thermal analyzer as in Experiment 1. As measurement conditions, α-alumina was used as a standard sample, nitrogen was used as a measurement atmosphere, and a temperature rise rate was 5° C./min. The measurement results of the softening point Ts are also shown in Table 2.

TABLE 2
Table 2 Nominal Compositions and Softening Points
of Lead-Free Glass Compositions G-1 to G-3

| | Nominal composition in | | | | Softening |
|---|---|---|---|---|---|
| | terms of oxide (mass %) | | | | point Ts |
| Sample No. | V₂O₅ | P₂O₅ | BaO | Sb₂O₃ | (° C.) |
| G-1 | 45 | 15 | 20 | 20 | 485 |
| G-2 | 65 | 25 | 5 | 5 | 395 |
| G-3 | 65 | 30 | 1 | 4 | 406 |

As shown in Table 2, it is found that a lead-free glass composition having a desirable characteristic temperature can be obtained by controlling the constituent components of the glass and the content. It is found that each of the crystallization peak temperatures Top of G-1 to G-3 is higher than Ts by 5° C. or higher.

### Preparation of Glass Frits GF-1 to GF-9 and Investigation on Properties of Bulk Body

The G-1 to G-3 powders prepared above and the filler powder were mixed at ratios shown in Table 3 to prepare glass frits GF-1 to GF-9 serving as bases for the electrically insulating film. As the filler powder, a SiO₂ powder having spherical particles (average particle diameter: 1 μm) was used.

A powder compact was formed using each of the prepared glass frits GF-1 to GF-9, and fired at a temperature higher than Ts of the used glass composition by 20° C. to prepare a bulk body corresponding to an electrically insulating film. Next, the bulk body was ground into a prism shape (4 mm×4 mm×15 mm) to obtain a sample for linear expansion coefficient measurement. The linear expansion coefficient of each of the measurement samples was measured using a thermal expansion meter (model: DL-9600, manufactured by ULVAC). The measurement temperature range of the linear expansion coefficient was from 30° C. to a temperature lower than Tg of the glass composition. The results are also shown in Table 3.

TABLE 3
Table 3 Results of Measuring Linear Expansion Coefficients
of Glass Frits GF-1 To GF-9 and Bulk Bodies

| Sample | Lead-free glass | Mixing Ratio | Linear expansion |
|---|---|---|---|
| No. | composition | (vol %) of filler | coefficient (ppm/° C.) |
| GF-1 | G-1 | 20 | 6.38 |
| GF-2 | | 50 | 4.18 |
| GF-3 | | 75 | 1.97 |
| GF-4 | G-2 | 20 | 6.26 |
| GF-5 | | 50 | 4.10 |
| GF-6 | | 75 | 1.94 |
| GF-7 | G-3 | 20 | 6.29 |
| GF-8 | | 50 | 4.12 |
| GF-9 | | 75 | 1.95 |

As shown in Table 3, it is found that a linear expansion coefficient of the electrically insulating film can be controlled by mixing the filler with the lead-free glass composition.

### Experiment 3

### Preparation of Glass Pastes GP-1 to GP-9

With 100 parts by mass of each of the glass frits GF-1 to GF-9 prepared in Experiment 2, 10 parts by mass of nitrocellulose as a resin binder and 20 parts by mass of a-terpineol as a solvent were mixed, thereby preparing glass pastes GP-1 to GP-9 for a soft magnetic composite material sheet.

### Preparation of Soft Magnetic Composite Material Sheets SMCM-1 to SMCM-28

The glass pastes GP-1 to GP-9 were applied to both main surfaces of each of the soft magnetic Fe-based alloy sheets SMP-1 and SMP-2 prepared in Experiment 1 according to the specifications shown in Table 4 described below to form soft magnetic composite material precursors. At this time, in order to control the electrically insulating film to a desired thickness, the thickness of the glass paste coating film was controlled.

Next, a drying process of heating to 170° C. and holding for 30 minutes was performed on the soft magnetic composite material precursors, and then a firing process of heating to a temperature higher than Ts of the used glass composition by 20° C. and holding for 30 minutes was performed, thereby preparing soft magnetic composite material sheets SMCM-1 to SMCM-28.

### Investigation on Properties of Soft Magnetic Composite Material Sheets SMCM-1 to SMCM-28

The iron loss Pi_{-1.0/400} (unit: W/kg) was measured in the same manner as in Experiment 1 for the prepared SMCM-1 to SMCM-28. The reduction rates (Pi reduction rates) from Pi_{-1.0/400} of SMP-1 alone and SMP-2 alone in Experiment 1 were calculated. The results are also shown in Table 4.

After the measurement of Pi_{-1.0/400}, the sample was cut, the Vickers hardness was measured for a cross-sectional portion of the soft magnetic Fe-based alloy sheet using a nanoindentation tester (model: ENT-1100a, manufactured by Elionix Inc.), and the amount of strain in the soft magnetic Fe-based alloy sheet was calculated. The results are also shown in Table 4.

TABLE 4
Table 4 Specifications and Property Investigation Results of
Soft Magnetic Composite Material Sheets SMCM-1 To SMCM-28

| | | | | Magnetic | | Amount |
|---|---|---|---|---|---|---|
| | | Electrically | | characteristics | | of strain |
| | Soft | insulating film | | | Pi | of soft |
| | magnetic | | Film | Iron | reduc- | magnetic |
| | Fe-based | Glass | thick- | loss | tion | Fe-based |
| Sample | alloy | paste | ness | Pi_{-1.0/400} | rate | alloy sheet |
| No. | sheet | No. | (μm) | (W/kg) | (%) | (μST) |
| SMCM-1 | SMP-1 | GP-1 | 1 | 1.68 | 19.2 | 28 |
| SMCM-2 | | GP-2 | | 1.31 | 37.0 | 79 |
| SMCM-3 | | GP-3 | | 1.18 | 43.3 | 131 |
| SMCM-4 | | GP-4 | | 1.72 | 17.3 | 25 |
| SMCM-5 | | GP-5 | | 1.38 | 33.7 | 65 |
| SMCM-6 | | GP-6 | | 1.22 | 41.3 | 106 |
| SMCM-7 | | GP-7 | | 1.72 | 17.3 | 25 |
| SMCM-8 | | GP-8 | | 1.37 | 34.1 | 67 |
| SMCM-9 | | GP-9 | | 1.22 | 41.3 | 109 |
| SMCM-10 | SMP-2 | GP-8 | | 0.82 | 76.8 | 51 |
| SMCM-11 | SMP-1 | GP-1 | 2 | 1.43 | 31.3 | 57 |
| SMCM-12 | | GP-2 | | 1.17 | 43.8 | 159 |
| SMCM-13 | | GP-3 | | 1.22 | 41.3 | 261 |
| SMCM-14 | | GP-4 | | 1.48 | 28.8 | 50 |
| SMCM-15 | | GP-5 | | 1.18 | 43.3 | 131 |
| SMCM-16 | | GP-6 | | 1.19 | 42.8 | 211 |
| SMCM-17 | | GP-7 | | 1.48 | 28.8 | 50 |
| SMCM-18 | | GP-8 | | 1.18 | 43.3 | 134 |
| SMCM-19 | | GP-9 | | 1.20 | 42.3 | 217 |
| SMCM-20 | SMP-1 | GP-1 | 5 | 1.18 | 43.3 | 141 |
| SMCM-21 | | GP-2 | | 1.25 | 39.9 | 397 |
| SMCM-22 | | GP-3 | | 1.45 | 30.3 | 653 |
| SMCM-23 | | GP-4 | | 1.19 | 42.8 | 125 |
| SMCM-24 | | GP-5 | | 1.25 | 39.9 | 327 |
| SMCM-25 | | GP-6 | | 1.29 | 38.0 | 529 |
| SMCM-26 | | GP-7 | | 1.19 | 42.8 | 126 |
| SMCM-27 | | GP-8 | | 1.25 | 39.9 | 335 |
| SMCM-28 | | GP-9 | | 1.31 | 37.0 | 544 |

As shown in Table 4, it is found that all SMCM-1 to SMCM-28 prepared according to the invention are significantly reduced in Pi_{-1.0/400} compared with Pi_{-1.0/400} of SMP-1 alone and SMP-2 alone.

### Investigation on Detailed Items and Frequency Dependence of Iron Loss Pi

The above SMCM-21 and SMP-1 alone were investigated for the detailed items and the frequency dependence of the iron loss Pi. Regarding the detailed items of Pi, Pi_{-1.0/400} measured using the Steinmetz equation was separated into a hysteresis loss and an eddy current loss. The results are shown in Table 5.

TABLE 5
Table 5 Detailed Items of iron loss Pi of Soft
Magnetic Composite Material Sheet SMCM-21
and Soft Magnetic Fe-based Alloy Sheet SMP-1

| | | Hysteresis loss | Eddy current loss |
|---|---|---|---|
| Sample No. | Pi_{-1.0/400} (W/kg) | (W/kg) | (W/kg) |
| SMCM-21 | 1.25 | 0.69 | 0.56 |
| SMP-1 | 2.08 | 1.51 | 0.57 |

As shown in Table 5, it can be seen that SMCM-21 has a significantly lower hysteresis loss than SMP-1 alone. The reason is considered to be that the tensile strain is applied to the electrically insulating film 2 in SMCM-21 as compared with SMP-1.

Regarding the frequency dependence of Pi, Pi was measured by using the same device as in Experiment 1 and changing only the frequency condition. The iron loss at 100 Hz is represented by Pi_{-1.0/100}, the iron loss at 200 Hz is represented by Pi_{-1.0/200}, the iron loss at 300 Hz is represented by Pi_{-1.0/300}, and the iron loss at 500 Hz is represented by Pi_{-1.0/500}. The results are shown in Table 6.

TABLE 6
Table 6 Frequency Dependency of Iron Loss Pi of
Soft Magnetic Composite Material Sheet SMCM-21
and Soft Magnetic Fe-Based Alloy Sheet SMP-1

| | Pi_{-1.0/100} | Pi_{-1.0/200} | Pi_{-1.0/300} | Pi_{-1.0/400} | Pi_{-1.0/500} |
|---|---|---|---|---|---|
| Sample No. | (W/kg) | (W/kg) | (W/kg) | (W/kg) | (W/kg) |
| SMCM-21 | 0.15 | 0.41 | 0.81 | 1.25 | 1.75 |
| SMP-1 | 0.39 | 0.88 | 1.45 | 2.08 | 2.77 |

As shown in Table 6, Pi also increases as the frequency increases. From this, it can be understood that when an increase in the rotation speed and an increase in the frequency during operation are advanced in order to increase the power of the electromechanical device, an energy loss and a decrease in efficiency caused by Pi become major problems.

In SMCM-21 according to the invention, Pi also increases as the frequency increases, and it is found that the degree of increase in Pi is gentle compared with SMP-1 alone. That is, it can be said that the soft magnetic composite material sheet according to the invention can be effectively used for an electromechanical device complied with an increase in rotation speed and an increase in frequency.

The above embodiments and experiments have been described to facilitate understanding of the invention, and the invention is not limited to the specific configuration described above. For example, a part of a configuration of the embodiment can be replaced with a configuration of the common technical knowledge of those skilled in the art, and the configuration of the common technical knowledge of those skilled in the art can be added to the configuration of the embodiment. That is, in the invention, with respect to some of the configurations of the embodiments and experiments of the present specification, deletion, replacement with other configurations, and addition of other configurations are possible without departing from the technical idea of the invention.

What is claimed is:

1. A soft magnetic composite material sheet comprising:
a soft magnetic Fe-based alloy sheet; and
an electrically insulating film formed on a surface of the soft magnetic Fe-based alloy sheet, wherein
the soft magnetic Fe-based alloy sheet is a Fe-based amorphous alloy sheet or a Fe-based nanocrystal alloy sheet,
the electrically insulating film contains a lead-free glass composition and has a linear expansion coefficient less than a linear expansion coefficient of the soft magnetic Fe-based alloy sheet, and
the glass composition has a softening point equal to or lower than a temperature at which a microstructure of the soft magnetic Fe-based alloy sheet is maintained.

2. The soft magnetic composite material sheet according to claim 1, wherein
the glass composition contains, when a nominal component is represented by an oxide,
V₂O₅ in an amount of 40 mass % or more and 70 mass % or less, P₂O₅ in an amount of 10 mass % or more and 35 mass % or less, a total content of V₂O₅ and P₂O₅ being 50 mass % or more and 98 mass % or less, and
two or more from the group consisting of BaO, Sb₂O₃, WO₃, ZnO, K₂O, Fe₂O₃, TeO₂, Ag₂O, and Li₂O in a total amount of 2 mass % or more and 50 mass % or less,
with a balance being unavoidable impurities.

3. The soft magnetic composite material sheet according to claim 2, wherein
the electrically insulating film contains an oxide particle filler in an amount of 75 vol % or less, and
the filler is one or more from the group consisting of SiO₂, ZrO₂, Al₂O₃, Nb₂O₅, ZrSiO₄, Zr₂(WO₄)(PO₄)₂, 2MgO·2Al₂O₃·5SiO₂, 3Al₂O₃·2SiO₂, and LiAlSiO₄.

4. The soft magnetic composite material sheet according to claim 3, wherein
the linear expansion coefficient of the electrically insulating film is less than 10 ppm/° C., and
the softening point of the glass composition is 500° C. or lower.

5. The soft magnetic composite material sheet according to claim 1, wherein
a tensile strain within a range of 1 μST or more and 1000 μST or less is generated in the soft magnetic Fe-based alloy sheet along an in-plane direction of the soft magnetic Fe-based alloy sheet.

6. The soft magnetic composite material sheet according to claim 2, wherein
a tensile strain within a range of 1 μST or more and 1000 μST or less is generated in the soft magnetic Fe-based alloy sheet along an in-plane direction of the soft magnetic Fe-based alloy sheet.

7. The soft magnetic composite material sheet according to claim 3, wherein
a tensile strain within a range of 1 μST or more and 1000 μST or less is generated in the soft magnetic Fe-based alloy sheet along an in-plane direction of the soft magnetic Fe-based alloy sheet.

8. The soft magnetic composite material sheet according to claim 4, wherein
a tensile strain within a range of 1 μST or more and 1000 μST or less is generated in the soft magnetic Fe-based alloy sheet along an in-plane direction of the soft magnetic Fe-based alloy sheet.

9. A method for producing a soft magnetic composite material sheet, which is a method for producing the soft magnetic composite material sheet according to claim 1, comprising:
a soft magnetic Fe-based alloy sheet preparing step of preparing the soft magnetic Fe-based alloy sheet;
a glass paste preparing step of preparing a glass paste serving as a base for the electrically insulating film;
a soft magnetic composite material precursor forming step of forming a soft magnetic composite material precursor by applying the glass paste to at least one main surface of the soft magnetic Fe-based alloy sheet; and
an electrically insulating film forming step of forming the electrically insulating film by performing a heat treatment on the soft magnetic composite material precursor.

10. The method for producing a soft magnetic composite material sheet according to claim 9, wherein
the heat treatment in the electrically insulating film forming step includes a drying process of heating and holding the soft magnetic composite material precursor at 120° C. or higher and 200° C. or lower, and a firing process of heating and holding the soft magnetic composite material precursor at a temperature higher than the softening point of the glass composition by 20° C. to 50° C., and
a highest temperature in the firing process is lower than a crystallization peak temperature of the glass composition and lower than a second crystallization temperature of the soft magnetic Fe-based alloy sheet.
